(19) United States
(12) Patent Application Publication
(10) Pub. No.: US 2026/0127208 A1
(43) Pub. Date: May 7, 2026

(54) SYSTEM AND METHOD FOR AN EXTENDABLE LOG ANALYSIS FRAMEWORK UTILIZING LARGE LANGUAGE MODELS

(71) Applicant: MEDIATEK INC., Hsinchu City (TW)

(72) Inventors: Chien-Han Su, Hsinchu City (TW); Hung-Chun Liu, Hsinchu City (TW); Po-Yuan Jeng, Hsinchu City (TW); Yu-Ting Wan, Hsinchu City (TW); Lei Chen, Hsinchu City (TW); Yung-Chih Chiu, Hsinchu City (TW); Yu-Chieh Lin, Hsinchu City (TW); Ji-Jie Lin, Hsinchu City (TW)

(73) Assignee: MEDIATEK INC., Hsinchu City (TW)

(21) Appl. No.: 19/380,973

(22) Filed: Nov. 6, 2025

Related U.S. Application Data
(60) Provisional application No. 63/716,772, filed on Nov. 6, 2024.

(51) Int. Cl. G06F 16/335

(52) U.S. Cl. CPC G06F 16/335

(57) ABSTRACT

A method for analyzing log data is disclosed. The method includes receiving log data; applying a plurality of filter modules to the log data to generate a plurality of filtered results; and selectively activating a subset of a plurality of checker modules to analyze the plurality of filtered results and generate a plurality of analysis results, wherein each of the subset of the plurality of checker modules is activated based on an established relationship with at least one of the plurality of filter modules and based on the filtered results. The method further includes generating report data from the plurality of analysis results by at least one writer module. A system for performing the method is also disclosed.

### CROSS REFERENCE TO RELATED APPLICATIONS

This application claims the benefit of U.S. Provisional Application No. 63/716,772, filed on Nov. 6, 2024. The content of the application is incorporated herein by reference.

### BACKGROUND

In the development of modern software and hardware products, system log analysis is an essential process for debugging and monitoring. Engineers analyze log data, which comprises a detailed record of system events and errors, to identify the root causes of issues.

Conventionally, log analysis is performed through manual inspection, a process that is inefficient and prone to error when dealing with large volumes of data. The task of locating a single problematic entry within extensive logs is time-consuming and requires significant domain expertise.

While automated log analysis tools such as Logstash and Splunk exist, they present their own limitations. A primary drawback is that these conventional solutions perform optimally only with structured log data, requiring additional parsing and normalization for common unstructured free-text logs.

Furthermore, many existing tools depend on brittle pattern-matching mechanisms, such as regular expressions (regex), which are tedious to create and maintain. Implementing custom, product-specific rules within these platforms also involves a steep learning curve for proprietary configurations, which hinders flexibility and rapid adaptation.

Therefore, a need exists for a more flexible and extendable log analysis framework capable of handling unstructured logs from multiple domains, while reducing the manual effort associated with pattern maintenance and custom logic implementation.

### SUMMARY

In one embodiment, a method for analyzing log data performed by a system comprising a processor and a memory is disclosed. The method comprises receiving log data by the processor; applying a plurality of filter modules to the log data by the processor to generate a plurality of filtered results; selectively activating a subset of a plurality of checker modules by the processor to analyze the plurality of filtered results and generate a plurality of analysis results, wherein each of the subset of the plurality of checker modules is activated based on an established relationship with at least one of the plurality of filter modules and based on the filtered results generated by the at least one of the plurality of filter modules; and generating report data from the plurality of analysis results by at least one writer module executed by the processor.

In another embodiment, a system for analyzing log data is disclosed. The system comprises a memory and a processor. The memory is configured to store log data, a plurality of filter modules, a plurality of checker modules, and at least one writer module. The processor is coupled to the memory and is configured to receive the log data; apply the plurality of filter modules to the log data to generate a plurality of filtered results; selectively activate a subset of the plurality of checker modules to analyze the plurality of filtered results and generate a plurality of analysis results, wherein each of the subset of the plurality of checker modules is activated based on an established relationship with at least one of the plurality of filter modules and based on the filtered results generated by the at least one of the plurality of filter modules; and execute the at least one writer module to generate report data from the plurality of analysis results.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic block diagram of a system for analyzing log data according to an embodiment of the present invention.

FIG. 2 is a sequence and data flow diagram illustrating a process for analyzing log data performed by the system in FIG. 1.

FIG. 3 is a block diagram illustrating a three-layer framework for the log analysis method according to an embodiment of the present invention.

FIG. 4 is a flowchart of a method for analyzing log data according to an embodiment of the present invention.

### DETAILED DESCRIPTION

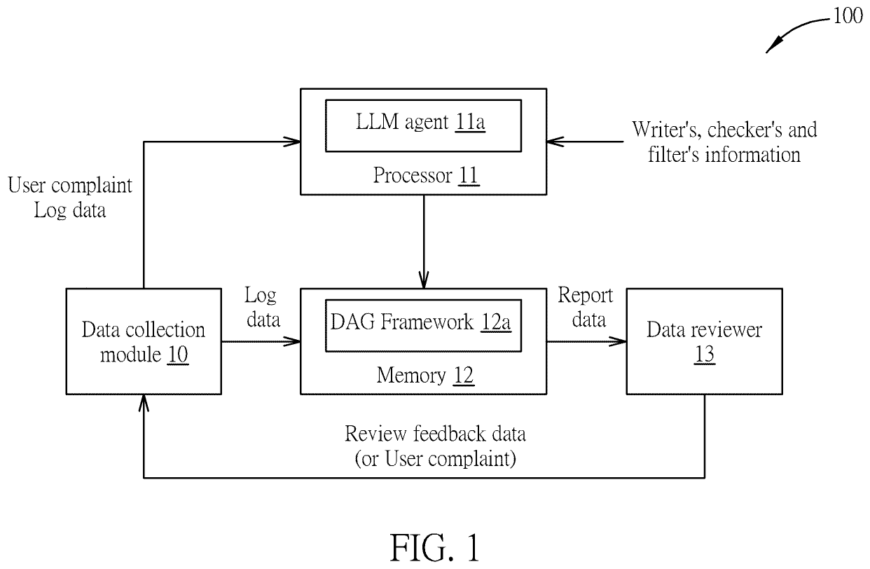

FIG. 1 is a schematic block diagram of a system 100 for analyzing log data according to an embodiment of the present invention. The system 100 provides an extendable and automated framework for log analysis that overcomes the limitations of conventional manual inspection and brittle pattern-matching tools. The system 100 is configured to dynamically construct and execute a customized analysis workflow, thereby improving the efficiency and accuracy of identifying issues within complex log data. The system 100 includes a data collection module 10, a processor 11, and a memory 12. In some embodiments, the system 100 further interacts with a data reviewer 13. The system 100 can also include only the processor 11 and the memory 12. For example, when the processor 11 executes a large language model, the data receiving function of the data collection module 10 can be integrated within the processor 11.

The processor 11 is coupled to the memory 12 and serves as the central processing hub of the system 100. The processor 11 can be implemented by any suitable processing hardware, such as a central processing unit (CPU), a graphics processing unit (GPU), a multi-core processor, or an application-specific integrated circuit (ASIC). The processor 11 is configured to execute a plurality of software modules stored in the memory 12 to perform the log analysis method. The memory 12 is a physical storage medium, such as a random-access memory (RAM), a non-volatile memory (e.g., flash memory), or a hard disk drive, configured to store instructions and data for the processor 11.

The data collection module 10 is an interface of the system 100, configured to receive input data. Specifically, the data collection module 10 is configured to receive log data and user complaint data. The log data includes system logs generated by a software or hardware product, and the user complaint data can be a textual description of an issue, or a user prompt specifying an analysis goal. The data collection module 10 can be implemented by hardware interfaces, such as a network interface controller (NIC) for receiving data from a network, or user input peripherals.

The processor 11 is configured to execute a large language model (LLM) agent 11a. The LLM agent 11a is a specialized software module that functions as the artificial intelligence (AI) core of the system 100. The LLM agent 11a receives the user complaint data and analyzes it in conjunction with predefined component information, referred to as writer's and checker's information. Based on this analysis, the LLM agent 11a is configured to dynamically construct a specific data structure, a directed acyclic graph (DAG) framework 12a, within the memory 12.

In certain embodiments, the system 100 is not limited to employing a single type or instance of a large language model. Instead, the system 100 can be configured to utilize a plurality of distinct AI models, each optimized for different tasks within the analysis workflow, thereby enhancing overall efficiency and performance.

For example, the LLM agent 11a, responsible for orchestrating the overall process (e.g., interpreting the user complaint, analyzing the initial log data, and constructing the DAG framework 12a), can be implemented using a powerful, general-purpose large language model capable of complex reasoning and planning.

Conversely, specific checker modules or writer modules within the workflow might incorporate or invoke smaller, more specialized AI models. Since the inputs to these modules (i.e., the filtered results) are cleaner and the tasks are more narrowly defined (e.g., verifying a specific condition or formatting a particular section of the report), less computationally intensive models might be sufficient and more cost-effective.

Furthermore, the embodiment described previously, where the registration interface facilitates the automatic generation of modules from natural language descriptions, can employ yet another AI model specifically trained or fine-tuned for code generation tasks. This multi-model architecture allows the system 100 to allocate appropriate computational resources and leverage the strengths of different AI technologies for various sub-tasks, resulting in a highly optimized and flexible log analysis framework.

In various embodiments, the LLM agent 11a is configured to operate in at least two distinct modes when defining the analysis workflow, based on the specificity of the received user complaint data.

In a first mode, referred to as a guided analysis mode, the user complaint data includes a specific user prompt with clear keywords or semantic intent (e.g., the “investigate performance bottlenecks” or “check for timeout errors”). In this mode, the LLM agent 11a is configured to parse the user prompt to identify the specific domain of the issue. Subsequently, the LLM agent 11a intelligently selects a targeted subset of filter modules and checker modules from the writer's and checker's information that are directly relevant to the identified domain. This approach significantly narrows the scope of the analysis, leading to a more efficient construction of the DAG framework 12a and a faster overall analysis time.

In a second mode, referred to as a comprehensive analysis mode, the user complaint data is generic (e.g., “analyze this log”) or absent. In this mode, where a specific focus is not provided, the LLM agent 11a is configured to construct a broad and exhaustive DAG framework 12a. This may involve selecting all available filter modules from the writer's and checker's information to ensure that no potential issues are overlooked. This mode provides a thorough, brute-force analysis to systematically scan for any known pattern of interest. This adaptability allows the system 100 to balance between rapid, focused analysis and broad, comprehensive investigation, providing significant flexibility over conventional, static analysis tools.

The DAG framework 12a, which resides in the memory 12, defines a complete, multi-stage analysis workflow specifically tailored for the received log data and user complaint. This workflow includes a plurality of filter modules, a plurality of checker modules, and at least one writer module, establishing the upstream and downstream relationships between these modules. By generating a specific DAG framework 12a, the processor 11 transforms the system 100 into a specialized log analysis apparatus optimized for the current task.

The processor 11 executes the analysis workflow defined by the DAG framework 12a. The processor 11 applies the plurality of filter modules to the log data received from the data collection module 10 to generate a plurality of filtered results. Subsequently, the processor 11 selectively activates a subset of the plurality of checker modules to analyze the plurality of filtered results and generate a plurality of analysis results. A technical improvement of this architecture is that a checker module is only activated when its associated upstream filter module produces a relevant result, thereby preventing the processor 11 from performing unnecessary computations and significantly improving the system's processing efficiency and speed compared to conventional systems that may apply all possible checks exhaustively.

Finally, the processor 11 executes at least one writer module defined in the DAG framework 12a to aggregate the analysis results from the activated checker modules and generate structured report data.

The data reviewer 13 receives the report data. The data reviewer 13 can be a human engineer interacting with the system 100 via an output device (e.g., a display), or an automated review agent (e.g., an AI agent) configured to programmatically analyze the report data. The data reviewer 13 can generate review feedback data, which is then fed back to the data collection module 10 to initiate a further refined analysis cycle, creating a closed-loop system for iterative issue investigation. This entire process, from receiving raw data to generating a targeted report and incorporating feedback, represents a concrete improvement over the prior art, enabling a more efficient, adaptive, and technically superior method for log data analysis.

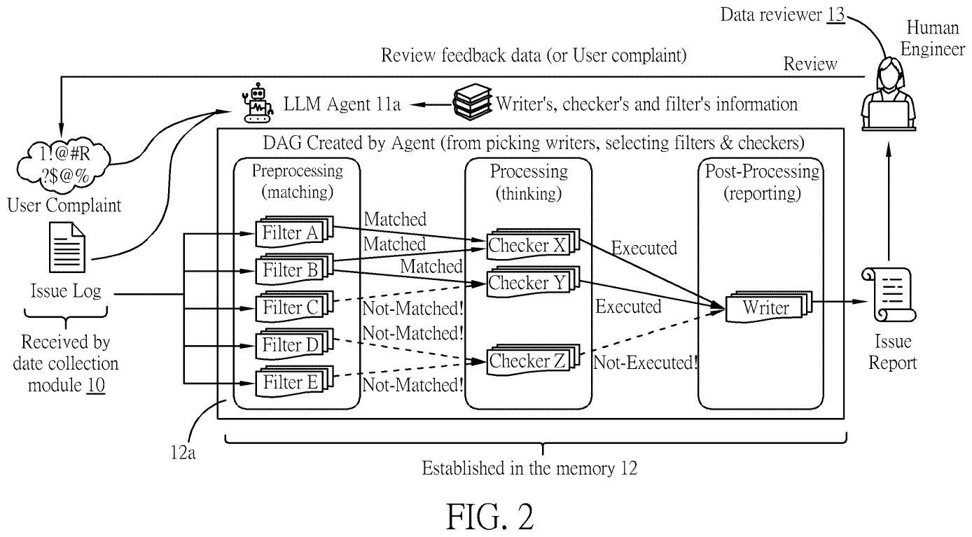

FIG. 2 is a sequence and data flow diagram illustrating a process for analyzing log data performed by the system 100. FIG. 2 provides a detailed view of the dynamic construction and execution of the analysis workflow managed by the LLM agent 11a.

The process begins with the data collection module 10 receiving input data, which includes an issue log and, in some embodiments, a user complaint. The issue log represents the raw log data to be analyzed, while the user complaint provides contextual information or a specific analysis directive. Both the issue log and the user complaint are provided to the LLM agent 11a.

The LLM agent 11a functions as the orchestrator of the analysis process. The LLM agent 11a accesses a predefined knowledge base, referred to as writer's and checker's information. This information includes a library of reusable filter modules, checker modules, and writer modules. Each embodies specific domain expertise or analysis logic. Based on its analysis of the input data (e.g., the user complaint and the issue log), the LLM agent 11a selects an appropriate set of filters, checkers, and a writer to address the specific problem at hand.

To facilitate the continuous growth and scalability of the system's analytical capabilities, the system 100 can further include a registration interface. This interface is configured to allow engineers and domain experts from various fields to systematically capture and contribute their domain knowledge to the knowledge base.

In one embodiment, an engineer can use the registration interface to define a new pattern. This involves submitting a filter module, which can be defined by providing specific keywords, a regular expression, or a script for identifying a low-level log entry. Concurrently, the engineer submits an associated checker module, which includes the higher-level logic or rules for verifying the issue based on the filter's output. The engineer also submits a corresponding writer module template, which includes a summary of the issue and, crucially, a set of predefined instructions that provide actionable guidance for resolving the issue, based on the engineer's experience.

Once submitted, this new pattern, including the filter, checker, and writer components, is stored and indexed within the writer's, checker's and filter's information knowledge base in the memory 12. The LLM agent 11a can then immediately leverage this newly registered pattern in subsequent analysis tasks. This mechanism transforms the system 100 from a static tool into a dynamic, evolving knowledge platform, where the collective expertise of an entire engineering organization can be systematically accumulated and algorithmically applied, ensuring that the system's effectiveness grows over time.

In a further embodiment, the registration interface is configured to leverage the capabilities of the LLM agent 11a, or another dedicated LLM, to automate the creation of the modules themselves. In this embodiment, an engineer is not required to submit executable code. Instead, the engineer can provide a description of an analysis rule in natural language.

For example, an engineer can submit a textual description such as, “define a pattern that is matched when a log entry containing “Error Code 78” appears, and a log entry containing “System Recovery Successful” does not appear within the subsequent 10 lines of the log.

The LLM agent 11a is configured to receive this natural language description, parse its logical structure and conditions, and automatically generate the corresponding executable code for a new checker module and its associated filter module. This auto-generated code is then packaged as a new, functional pattern and stored in the writer's, checker's and filter's information knowledge base. This embodiment provides a significant technical improvement by drastically lowering the technical barrier for contributing domain expertise, allowing engineers to define complex analysis logic without writing any code, thereby accelerating the expansion of the system's knowledge base.

Subsequently, the LLM agent 11a dynamically constructs a DAG framework 12a, which is established in the memory 12. The DAG framework 12a defines a tailored, multi-stage analysis workflow. As illustrated in FIG. 2, this workflow is organized into a preprocessing stage, a processing stage, and a post-processing stage.

The construction of the DAG framework 12a by the LLM agent 11a is performed through a systematic, backward-chaining dependency resolution process. This process ensures that only necessary modules are included in the analysis workflow.

The process is initiated after the LLM agent 11a selects at least one writer module from the predefined writer templates, for example, based on the user complaint. The LLM agent 11a then inspects the selected writer module to identify its upstream requirements, which specify a set of one or more checker modules whose analysis results are necessary for generating the report.

Subsequently, for each identified checker module, the LLM agent 11a recursively performs a similar dependency check. It inspects the checker module to identify its own upstream requirements, which specify a set of one or more filter modules that must be executed to provide the necessary input data for the checker's analysis logic.

This recursive, top-down resolution process, analogous to a depth-first search, continues until all dependencies for all required modules are identified. The LLM agent 11a then assembles these identified modules and their established upstream and downstream relationships into the final, coherent DAG framework 12a. This method of construction ensures that the resulting analysis workflow is lean, efficient, and precisely tailored to the problem defined by the initial writer selection.

A central concept of the analysis workflow is a “pattern”. A pattern represents a specific, detectable issue and is defined by a combination of one or more filter modules and one or more checker modules. The system 100 is extendable because patterns are not restricted to a rigid one-to-one relationship between a filter and a checker; instead, they can be flexibly defined to represent both simple and complex conditions.

For example, a simple pattern can be defined by a single filter module and a single checker module. The filter module can be configured to find a specific error string (e.g., “memory allocation failed”), and the checker module can be configured to confirm that this error is not followed by a recovery message.

In another embodiment, a complex pattern can be defined by a plurality of filter modules and a plurality of checker modules. For instance, a complex pattern for a system hang-up might require three distinct filter modules to be matched simultaneously (e.g., one filter for a “watchdog timeout” message, another for a “CPU usage at 100%” log, and a third for a “message queue full” status). The outputs of these three filters are then fed into two different checker modules. A first checker module might correlate the watchdog timeout with the high CPU usage, while a second checker module validates the full message queue. Only if both checker modules confirm their respective conditions is the complex pattern considered “matched”. This flexible, combinatorial approach allows engineers to define and register highly specific and nuanced issue signatures, making the framework exceptionally powerful and scalable.

The preprocessing stage performs a matching function and includes a plurality of filter modules (e.g., a Filter A, a Filter B, a Filter C, a Filter D, a Filter E). The processor 11 applies these filter modules to the issue log. Each filter module is a specialized software routine configured to perform a low-level pattern search to extract lines or segments of data that are indicative of an issue. For example, a filter module can be configured to scan for specific keywords (e.g., “Error”, “Failed”, “Timeout”), match predefined regular expressions, identify numerical values that exceed a certain threshold, or detect a specific sequence of log events. If a filter module finds its target pattern, its result is marked as “Matched”; otherwise, the result is marked as “Not-Matched”.

The processing stage performs a thinking function and includes a plurality of checker modules (e.g., a Checker X, a Checker Y, a Checker Z). Each checker module embodies a higher-level analysis logic or engineering know-how. A checker module receives the raw filtered results from its upstream filter modules and performs a contextual analysis to determine if an actual, verifiable issue exists. For example, a checker module can be configured to correlate multiple filtered results to identify a root cause, apply a rule based on domain expertise (e.g., if log event A occurs without subsequent event B, then an error condition is confirmed), or validate system state information surrounding a filtered log entry.

A technical improvement of the system 100 is the selective activation of these checker modules. A checker module is only executed by the processor 11 if its corresponding upstream filter module, as defined by the relationship established in the DAG framework 12a, has a “Matched” result. For instance, since the Filter A and the Filter B are matched, the Checker X and the Checker Y are executed. Conversely, because the Filter D and the Filter E are not matched, the Checker Z is not executed, thereby preventing the processor from performing unnecessary analysis and conserving computational resources.

The framework in FIG. 2 supports flexible relationships. For example, the matched result from the Filter B is provided to both Checker X and Checker Y, demonstrating that a single filter module can feed into a plurality of checker modules. In another embodiment, matched results from a plurality of filter modules (e.g., Filter B and Filter C) are provided to a single checker module (e.g., Checker Y), demonstrating that a plurality of filter modules can feed into a single checker module. In other words, the relationship between the plurality of filter modules and the plurality of checker modules is not a one-to-one mapping.

The post-processing stage performs a reporting function and includes at least one writer module. The writer module receives and aggregates the analysis results from all executed checker modules (i.e., the Checker X and Checker Y). The writer module then compiles these results into a structured and human-readable issue report.

The writer module is configured to compile the aggregated analysis results into a structured and multi-part report. In one embodiment, the report data includes a summary section and a detailed instruction section.

The summary section provides a high-level overview of the analysis, for example, in a tabular format. This table can list each pattern that was checked by the system, identified by a pattern name or a pattern type, and include an existence field indicating whether the pattern was matched in the log data (e.g., “Yes” or “No”).

For each pattern that is marked as “Matched” in the summary section, the detailed instruction section provides further information. This section includes not only the specific analysis results generated by the corresponding checker modules, but also a set of predefined instructions. These predefined instructions, which are retrieved from the writer's, checker's and filter's information knowledge base, provide concrete, actionable guidance for a reviewer. For example, the instructions can include recommended next steps for debugging, a list of potential root causes, or contact information for the domain expert responsible for the relevant system component. This feature directly translates the stored domain expertise into practical solutions, significantly accelerating the issue resolution process.

Finally, the issue report is provided to a data reviewer 13, such as a human engineer. The data reviewer 13 can analyze the report and provide review feedback data. This feedback can be used to initiate a new, more refined analysis cycle, forming a closed-loop system that allows for iterative problem-solving and continuous improvement of the analysis process itself.

The feedback loop provides a mechanism for the system 100 to learn and adapt over time. In an embodiment, the review feedback data is not merely a trigger for re-analysis, but is a structured input that the LLM agent 11a uses to refine its future operations.

For example, the data reviewer 13 can provide feedback indicating that a specific matched pattern in a report was a “false positive”. The LLM agent 11a is configured to receive this feedback and can subsequently adjust the internal parameters of the analysis workflow, for instance, by lowering the priority of the checker module that generated the false positive, or by requiring an additional condition to be met before that specific pattern is reported again.

In another example, the reviewer can provide feedback that includes a new keyword or log signature that was manually identified as relevant but was missed by the initial set of filters. The LLM agent 11a can be configured to parse this feedback and automatically propose or create a new, simple filter module incorporating this keyword, and add it to the writer's, checker's and filter's information knowledge base for use in future analyses. This adaptive learning capability, driven by structured user feedback, ensures that the system's accuracy and knowledge base evolve, making the analysis process progressively more intelligent and effective.

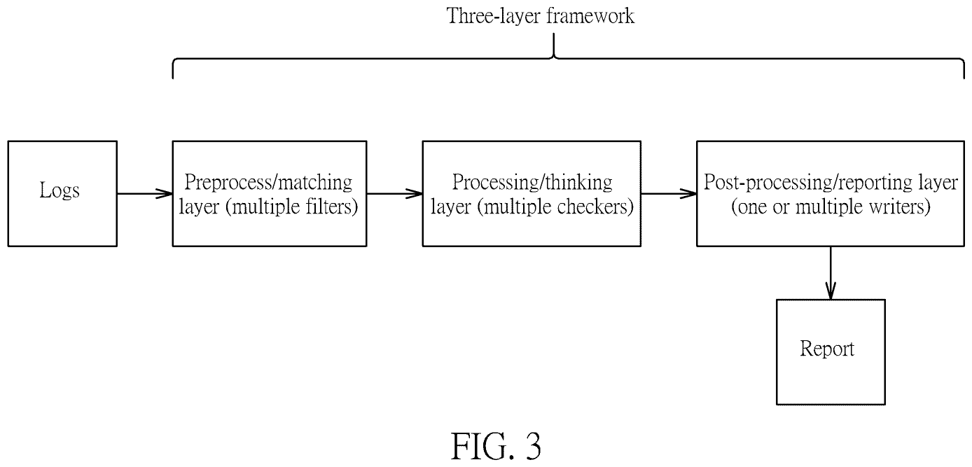

FIG. 3 is a block diagram illustrating a three-layer framework for the log analysis method according to an embodiment of the present invention. This diagram provides a high-level, conceptual overview of the core analysis process, which is structured into three distinct logical stages.

The process begins with an input of raw logs. These logs are first processed by a preprocess/matching layer. This layer includes a plurality of filter modules and is configured to perform low-level pattern searching and data extraction, analogous to the function of eyes searching for known patterns.

The output from the preprocess/matching layer is then fed into a processing/thinking layer. This layer includes a plurality of checker modules and is configured to perform higher-level contextual analysis, analogous to the function of a brain analyzing collected patterns.

Finally, the analysis results from the processing/thinking layer are passed to a post-processing/reporting layer. This layer includes one or multiple writer modules and is configured to aggregate the analysis results and compile them into a final, structured report, analogous to the function of a hand writing down the report. The final output of the framework is the report, which is then provided to a data reviewer. This structured, multi-stage approach ensures a systematic and thorough analysis of the log data.

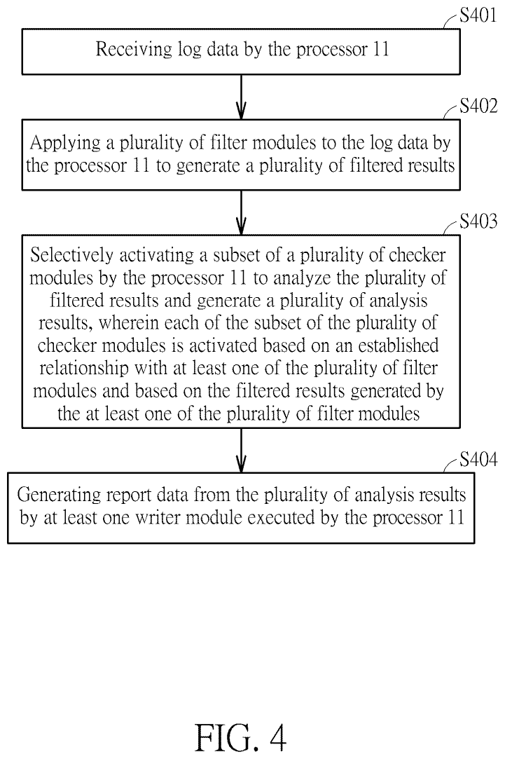

FIG. 4 is a flowchart of a method for analyzing log data according to an embodiment of the present invention. The method for analyzing log data by the system 100 includes step S401 to step S404. Any hardware or technology modification falls into the scope of the present invention. Step S401 to step S404 are illustrated below.
step S401: receiving log data by the processor 11;
step S402: applying a plurality of filter modules to the log data by the processor 11 to generate a plurality of filtered results;
step S403: selectively activating a subset of a plurality of checker modules by the processor 11 to analyze the plurality of filtered results and generate a plurality of analysis results, wherein each of the subset of the plurality of checker modules is activated based on an established relationship with at least one of the plurality of filter modules and based on the filtered results generated by the at least one of the plurality of filter modules;
step S404: generating report data from the plurality of analysis results by at least one writer module executed by the processor 11.

Details of step S401 to step S404 are previously illustrated. Thus, they are omitted here. The method for analyzing log data, by implementing steps S401 to S404, provides several significant benefits and technical advantages over conventional log analysis techniques. Primarily, the method automates the analysis process, significantly reducing the manual effort and time engineers spend inspecting large volumes of log data. The selective activation of checker modules in step S403, in particular, embodies a dynamic pruning mechanism that prevents the processor from performing unnecessary computations on irrelevant data, thereby improving processing efficiency and speed. Furthermore, the modular framework is inherently extendable and scalable. It functions as a dynamic knowledge base where domain expertise from different engineers can be systematically captured as filter and checker modules. By freeing engineers from repetitive log inspection tasks, the method allows them to focus on more critical problem resolution activities, leading to boosted team productivity and improved overall product quality.

In summary, embodiments of the present invention provide a method and system for an extendable and automated log analysis framework. Unlike conventional methods that rely on brittle, manually maintained patterns and are inefficient for unstructured logs, the disclosed embodiments leverage a large language model (LLM) agent to dynamically define and execute a tailored analysis workflow. This workflow is structured as a multi-layer framework including a plurality of filter modules, a plurality of checker modules, and at least one writer module. A key technical improvement is the selective activation of checker modules based on the results from upstream filter modules, which prevents unnecessary computations and improves processing efficiency. Furthermore, the framework is highly extendable, enabling the systematic capture of domain expertise through a registration interface that supports both code submission and automated module generation from natural language descriptions. By incorporating a feedback loop, the system is capable of learning and adapting over time. As a result, the embodiments provide a robust, scalable, and efficient solution for log analysis that reduces manual effort, boosts productivity, and improves the accuracy of issue detection in complex systems.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for analyzing log data, the method performed by a system comprising a processor and a memory, the method comprising:
receiving log data by the processor;
applying a plurality of filter modules to the log data by the processor to generate a plurality of filtered results;
selectively activating a subset of a plurality of checker modules by the processor to analyze the plurality of filtered results and generate a plurality of analysis results, wherein each of the subset of the plurality of checker modules is activated based on an established relationship with at least one of the plurality of filter modules and based on the filtered results generated by the at least one of the plurality of filter modules; and
generating report data from the plurality of analysis results by at least one writer module executed by the processor.

2. The method of claim 1, further comprising:
defining an analysis workflow by a large language model (LLM) agent executed by the processor prior to applying the plurality of filter modules;
wherein the analysis workflow comprises the plurality of filter modules, the plurality of checker modules, and the at least one writer module, and wherein the established relationship is defined within the analysis workflow.

3. The method of claim 2, wherein the LLM agent defines the analysis workflow further based on request data received by the processor, and wherein the request data comprises at least one of a user complaint or a user prompt.

4. The method of claim 3, wherein defining the analysis workflow comprises:
selecting the at least one writer module from a plurality of predefined writer modules based on the request data;
identifying the plurality of checker modules based on upstream requirements associated with the selected at least one writer module; and
identifying the plurality of filter modules based on upstream requirements associated with the identified plurality of checker modules.

5. The method of claim 1, wherein the established relationship specifies at least one of:
at least one of the plurality of filter modules is an upstream module for at least two of the plurality of checker modules; or
at least two of the plurality of filter modules are upstream modules for at least one of the plurality of checker modules.

6. The method of claim 1, wherein generating the report data comprises aggregating the plurality of analysis results from one or more of the plurality of checker modules by the at least one writer module.

7. The method of claim 1, further comprising:
receiving review feedback data by the processor, wherein the review feedback data is generated by a reviewer based on the report data; and
re-applying the plurality of filter modules to the log data by the processor based on the review feedback data.

8. The method of claim 2, wherein the analysis workflow is structured as a directed acyclic graph (DAG), wherein the plurality of filter modules, the plurality of checker modules, and the at least one writer module constitute a plurality of nodes in the DAG.

9. The method of claim 2, wherein the LLM agent defines the analysis workflow by selecting from a plurality of predefined modules stored in the memory, and wherein the plurality of predefined modules comprise a plurality of writer templates and a plurality of checker rules embodying domain expertise.

10. The method of claim 1, wherein the report data comprises a plurality of predefined instructions, and wherein each of the plurality of predefined instructions is associated with at least one of the plurality of analysis results to provide actionable guidance to a reviewer.

11. A system for analyzing log data, the system comprising:
a memory configured to store log data, a plurality of filter modules, a plurality of checker modules, and at least one writer module; and
a processor coupled to the memory, the processor configured to:
receive the log data;
apply the plurality of filter modules to the log data to generate a plurality of filtered results;
selectively activate a subset of the plurality of checker modules to analyze the plurality of filtered results and generate a plurality of analysis results, wherein each of the subset of the plurality of checker modules is activated based on an established relationship with at least one of the plurality of filter modules and based on the filtered results generated by the at least one of the plurality of filter modules; and
execute the at least one writer module to generate report data from the plurality of analysis results.

12. The system of claim 11, wherein the processor is further configured to:
execute a large language model (LLM) agent to define an analysis workflow prior to applying the plurality of filter modules;
wherein the analysis workflow comprises the plurality of filter modules, the plurality of checker modules, and the at least one writer module, and wherein the established relationship is defined within the analysis workflow.

13. The system of claim 12, wherein the LLM agent defines the analysis workflow further based on request data received by the processor, and wherein the request data comprises at least one of a user complaint or a user prompt.

14. The system of claim 13, wherein the processor is configured to define the analysis workflow by:
selecting the at least one writer module from a plurality of predefined writer modules based on the request data;
identifying the plurality of checker modules based on upstream requirements associated with the selected at least one writer module; and
identifying the plurality of filter modules based on upstream requirements associated with the identified plurality of checker modules.

15. The system of claim 11, wherein the established relationship specifies at least one of:
at least one of the plurality of filter modules is an upstream module for at least two of the plurality of checker modules; or
at least two of the plurality of filter modules are upstream modules for at least one of the plurality of checker modules.

16. The system of claim 11, wherein the processor is configured to execute the at least one writer module to generate the report data by aggregating the plurality of analysis results from one or more of the plurality of checker modules.

17. The system of claim 11, wherein the processor is further configured to:
receive review feedback data, wherein the review feedback data is generated by a reviewer based on the report data; and
re-apply the plurality of filter modules to the log data based on the review feedback data.

18. The system of claim 12, wherein the analysis workflow is structured as a directed acyclic graph (DAG), and wherein the plurality of filter modules, the plurality of checker modules, and the at least one writer module constitute a plurality of nodes in the DAG.

19. The system of claim 12, wherein the memory is further configured to store a plurality of predefined modules, and wherein the LLM agent defines the analysis workflow by selecting from the plurality of predefined modules, and wherein the plurality of predefined modules comprise a plurality of writer templates and a plurality of checker rules embodying domain expertise.

20. The system of claim 11, wherein the report data comprises a plurality of predefined instructions, and wherein each of the plurality of predefined instructions is associated with at least one of the plurality of analysis results to provide actionable guidance to a reviewer.
